(19) United States
(12) Patent Application Publication
(10) Pub. No.: US 2005/0208248 A1
(43) Pub. Date: Sep. 22, 2005

(54) Automotive fuel hose and method for producing the same

(75) Inventors: Shinji Ilo, Komaki-shi (JP); Hiroaki Ito, Kasugai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/080,639

(22) Filed: Mar. 16, 2005

(30) Foreign Application Priority Data
Mar. 18, 2004 (JP) JP2004-078829
Jul. 26, 2004 (JP) JP2004-217915

(51) Int. Cl. B65D 1/00; B32B 1/08

(52) U.S. Cl. 428/36.91

(57) ABSTRACT

An automotive fuel hose excellent in interlaminar adhesion between a low permeability resin layer and a rubber layer, wherein the low permeability resin layer and the rubber layer are directly adhered to each other without forming an adhesive layer at the interface between both layers. The automotive fuel hose has a laminated structure of a low permeability resin layer and a rubber layer, the low permeability resin layer is formed by the following (A) and the rubber layer is formed by the following (B). (A) a polyphenylene sulfide resin containing a softening component, or a modified fluororesin. (B) a rubber composition composed of at least one of an amine additive and an amine vulcanizing agent as an essential component.

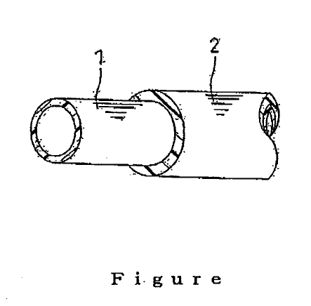

### BACKGROUND OF THE INVENTION

1. Field of the Invention

The present invention relates to an automotive fuel hose and a method for producing the same, and, more specifically, to an automotive fuel hose for transportation of an automotive fuel such as gasoline, alcohol-containing gasoline or diesel fuel and a method for producing the same.

2. Description of the Art

With growing worldwide awareness of environmental issues, the control of the amount of hydrocarbon vapor emission from an automotive fuel hose has been enhanced. Particularly in the United States, stringent regulations against vapor emission have recently come into effect. To cope with the hydrocarbon vapor emission control in this situation, automotive fuel hoses have been proposed which include a layer having low fuel permeability composed of a fluororesin, a polyester resin, a polyphenylene sulfide resin or the like (just refer to ‘low permeability resin layer’, hereinafter). However, low permeability resins used for forming the low permeability resin layer are highly rigid and costly. Therefore, a hose having a laminated structure of a thin low permeability resin layer and a thermoplastic resin layer composed of polyamide (PA) or the like has been proposed (see Japanese Unexamined Patent Publication No. 7-299855 (1995)).

However, in the above hose, the low permeability resin layer does not adhere well to the thermoplastic resin layer composed of polyamide or the like. Therefore, the low permeability resin layer and the thermoplastic resin layer should be laminated by providing an adhesive layer therebetween, alternatively, a surface treatment such as a corona discharge treatment should be applied to the surface of the low permeability resin layer. The formation of the adhesive layer or the surface treatment leads to a cost increase and the difficulty of quality control. In addition, since the above hose has an outermost layer composed of a resin, there is a disadvantage that the hose is inferior in resistance to chipping. For this reason, a rubber layer called a protector layer should be formed on the outer peripheral surface of the resin layer. However, the formation of the rubber layer leads to a further cost increase Moreover, the rubber layer may be used instead of the thermoplastic resin layer composed of polyamide or the like and may be laminated on the low permeability resin layer, but, there is a disadvantage that the low permeability resin layer is difficult to adhere to the rubber layer.

In view of the foregoing, it is an object of the present invention to provide an automotive fuel hose excellent in interlaminar adhesion between a low permeability resin layer and a rubber layer, wherein the low permeability resin layer and the rubber layer are directly adhered to each other without forming an adhesive layer at the interface between both layers, and a method for producing the same.

### SUMMARY OF THE INVENTION

In order to achieve the aforesaid object, according to a first aspect of the present invention, there is provided an automotive fuel hose comprising a laminated structure of a low permeability resin layer and a rubber layer, the low permeability resin layer being formed by the following (A) and the rubber layer being formed by the following (B). According to a second aspect of the present invention, there is provided a method for producing an automotive fuel hose comprising the steps of: preparing a laminated hose body of a low permeability resin layer using the following (A) and an unvulcanized rubber layer using the following (B) and vulcanizing the laminated hose body so as to adhere the low permeability resin layer and the unvulcanized rubber layer.
(A) a polyphenylene sulfide resin containing a softening component or a modified fluororesin.
(B) a rubber composition composed of at least one of an amine additive and an amine vulcanizing agent as an essential component.

The inventors of the present invention conducted intensive studies to obtain an automotive fuel hose excellent in interlaminar adhesion between a low permeability resin layer and a rubber layer without forming an adhesive layer at the interface between the low permeability resin layer and the rubber layer (adhesiveless). As a result, they found that when an automotive fuel hose has a laminated structure of a low permeability resin layer and a rubber layer, the low permeability resin layer is formed by a polyphenylene sulfide resin containing a softening component such as a thermoplastic elastomer, or a modified fluororesin, and the rubber layer is formed by a rubber composition composed of at least one of an amine additive and an amine vulcanizing agent as an essential component, interlaminar adhesion between the low permeability resin layer and the rubber layer is improved so that both layers are directly adhered to each other without the use of an adhesive. Thus, they attained the present invention. It is thought that the automotive fuel hose of the invention has the above-mentioned effects because of the following reason. Namely, it is thought that interlaminar adhesion between the low permeability resin layer and the rubber layer is significantly improved because a softening component such as a thermoplastic elastomer in a polyphenylene sulfide resin, a compatibilizer used when mixing the softening component, or a modified component in a modified fluororesin used for forming the low permeability resin layer interacts or bonds with an amine additive or an amino group in an amine vulcanizing agent in the rubber layer.

As described above, the automotive fuel hose of the invention has a laminated structure of a low permeability resin layer and a rubber layer, the low permeability resin layer is formed by a polyphenylene sulfide resin containing a softening component such as a thermoplastic elastomer, or a modified fluororesin, and the rubber layer is formed by a rubber composition composed of at least one of an amine additive and an amine vulcanizing agent as an essential component. For this reason, the low permeability resin layer and the rubber layer are firmly and directly adhered to each other without forming an adhesive layer at the interface between the low permeability resin layer and the rubber layer (adhesiveless) because a softening component such as a thermoplastic elastomer in a polyphenylene sulfide resin, a compatibilizer used when mixing the softening component, or a modified component in a modified fluororesin used for forming the low permeability resin layer interacts or bonds with an amine additive or an amino group in an amine vulcanizing agent in the rubber layer.

Further, when a polyolefin component such as a polyolefin thermoplastic elastomer is used as the softening component, interlaminar adhesion between the rubber layer and the low permeability resin layer is further improved.

Still further, when the specific amine additive or amine vulcanizing agent is used, interlaminar adhesion between the rubber layer and the low permeability resin layer is further improved.

A method for producing an automotive fuel hose of the invention, for example, comprises the steps of: preparing a laminated hose body of two layers by extruding a low permeability resin layer using the above-mentioned (A) into a hose shape and extruding an unvulcanized rubber layer using the above-mentioned (B) into a hose shape on a periphery thereof, and vulcanizing the laminated hose body so as to adhere the low permeability resin layer and the unvulcanized rubber layer. Thus, a conventional surface treatment process of the low permeability resin layer is not necessary. For this reason, the production process is simplified, the production time is shortened, and the production cost is lowered. As described above, since the method of the invention does not use adhesives, simplification of molding processes can be realized and the production cost is lowered. In addition, since the control of adhesives is not necessary, the cause of adhesion failure decreases and adhesion reliability is improved.

### BRIEF DESCRIPTION OF THE DRAWING

The sole FIGURE of the drawing is a diagram illustrating the construction of an exemplary automotive fuel hose according to the present invention.

### DESCRIPTION OF THE PREFERRED EMBODIMENTS

Embodiments of the present invention will hereinafter be described in detail.

As shown in the FIGURE, an automotive fuel hose according to one embodiment of the present invention includes a low permeability resin layer 1 and a rubber layer 2 laminated on an outer peripheral surface of the low permeability resin layer 1.

The low permeability resin layer 1 is formed by the following (A) and the rubber layer 2 is formed by the following (B), which is the main feature of the present invention.
(A) a polyphenylene sulfide resin containing a softening component, or a modified fluororesin.
(B) a rubber composition composed of at least one of an amine additive and an amine vulcanizing agent as an essential component.

The automotive fuel hose of the invention is not limited to a two-layer structure, as shown in the FIGURE. When a low permeability resin layer 1 is sandwiched between rubber layers by forming a rubber layer 2 on an inner peripheral surface and an outer peripheral surface of the low permeability resin layer 1, sealability with a joint, insertability into the joint, flexibility and low-temperature impact resistance are further improved. Further, in the automotive fuel hose of the invention, the order of laminating the low permeability resin layer 1 and the rubber layer 2 is not particularly limited. However, when the rubber layer 2 is formed as an outermost layer, the rubber layer 2 plays a role as a protector layer, resulting in improving flexibility, resistance to chipping, flame resistance, low-temperature impact resistance, caulking resistance and the like.

The polyphenylene sulfide resin (PPS resin) as the material for forming the low permeability resin layer 1 contains a softening component. Namely, a PPS resin not containing such a softening component has remarkably inferior adhesion to the rubber layer 2.

In addition, in the present invention, a softening component means a thermoplastic elastomer, a thermoplastic resin, rubber or the like.

Here the thermoplastic elastomer means a macromolecular material which shows such a property as vulcanized rubber at an ordinary temperature, but is capable of plastic deformation at a high-temperature so as to be formed by means of a processing machine for plastic materials.

The thermoplastic elastomer as the softening component is not particularly limited as long as it has good adhesion to the rubber layer 2. Examples thereof include a polyolefin thermoplastic elastomer (TPO), a polyurethane thermoplastic elastomer (TPU), a polyester thermoplastic elastomer (TPEE), a polyamide thermoplastic elastomer, a fluorothermoplastic elastomer, a polystyrene thermoplastic elastomer, a polydiene thermoplastic elastomer, a chlorinated thermoplastic elastomer and the like. They may be used either alone or in combination. Among them, a polyolefin thermoplastic elastomer is preferred because it has especially good adhesion to the rubber layer 2.

The thermoplastic resin as the softening component is not particularly limited as long as it has good adhesion to the rubber layer 2. Examples thereof include a polyethylene resin, a polystyrene resin, a polyamide resin, a polyvinyl chloride resin, a fluororesin, polypropylene, polybutene, polyvinyl acetate and the like. They may be used either alone or in combination.

The rubber as the softening component is not particularly limited as long as it has good adhesion to the rubber layer 2. Examples thereof include natural rubber, butyl rubber, halogenated butyl rubber, acrylic rubber, butadiene rubber, acrylonitrile-butadiene rubber (NBR), styrene-butadiene rubber (SBR), hydrogenated NBR (H-NBR), isoprene rubber, ethylene-propylene rubber (EPM, EPDM), fluororubber, urethane rubber, silicone rubber and the like. They may be used either alone or in combination.

These softening components are included, for example, by heating and mixing a softening component material and a PPS resin on their own or in the presence of a compatibilizer so as to disperse or compatibilize the softening component material in the PPS resin.

The PPS resin including the softening component is not particularly limited. Examples thereof include a linear type resin, a semilinear type resin, a crosslinking type resin and the like. They may be used either alone or in combination. Among them, a linear type resin and a semilinear type resin are preferably used. In addition, the PPS resin may be modified by a functional group such as an epoxy group, a hydroxyl group, a carboxylic anhydride group, a carboxylic acid group, an acrylate group, a carbonate group or an amino group.

The softening component is preferably present in the range of 1 to 45% by weight, more preferably 2 to 40%, relative to the total amount of a specific PPS resin (PPS resin containing a softening component). If the proportion of the softening component is smaller than 1% by weight relative to the total amount of the specific PPS resin, adhesion to the rubber layer 2 tends to be inferior. If the proportion of the softening component is greater than 45% by weight relative to the total amount of the specific PPS resin, a characteristic such as low fuel permeability inherent in PPS resins tends to be poor.

Next, as the material for forming the low fuel permeability resin layer, a modified fluororesin is used.

In the present invention, the modified fluororesin is obtained by copolymerizing or graft-copolymerizing a comonomer having a functional group (generally, a vinyl compound) or the like at the synthesis of a fluororesin, or by introducing a functional group (a modified group) or the like into the main chain or the side chain of the fluororesin by a very small amount of substitution reaction such that a characteristic inherent in fluororesins is not impaired.

The functional group introduced into the fluororesin is not particularly limited as long as it has good adhesion to the rubber layer 2. Examples thereof include a carboxylic acid group, a carboxylic acid anhydride group, a carbonate group, a hydroxyl group, an epoxy group, an acrylate group and the like. Among them, a carboxylic acid group, a carboxylic acid anhydride group and a carbonate group are preferably used because of their excellent adhesion and heat stability.

The fluororesin used for the modified fluororesin is not specifically limited. Examples thereof include an ethylene-tetrafluoroethylene copolymer (ETFE), a tetrafluoroethylene-hexafluoropropylene-vinylidene fluoride copolymer (THV), polyvinylidene fluoride resin (PVDF), a tetrafluoroethylene-hexafluoropropylene copolymer (FEP), an ethylene-chlorotrifluoroethylene copolymer (ECTFE), a vinylidene fluoride-hexafluoropropylene copolymer, a vinylidene fluoride-chlorotrifluoroethylene copolymer, a vinylidene fluoride-tetrafluoroethylene copolymer, a vinylidene fluoride-tetrafluoroethylene-hexafluoropropylene-perfluoroalkoxyvinyl ether copolymer, polyvinyl fluoride (PVF), polychlorotrifluoroethylene (CTFE), a hexafluoropropylene-perfluoroalkylvinyl ether copolymer, a vinylidene fluoride-perfluoroalkylvinyl ether copolymer, a tetrafluoroethylene-hexafluoropropylene-perfluoroalkylvinyl ether copolymer, an ethylene-tetrafluoroethylene-hexafluoropropylene copolymer, a vinylidene fluoride-tetrafluoroethylene-perfluoroalkylvinyl ether copolymer, a vinylidene fluoride-hexafluoropropylene-perfluoroalkylvinyl ether copolymer, an ethylene-tetrafluoroethylene-perfluoroalkylvinyl ether copolymer, an ethylene-hexafluoropropylene-perfluoroalkylvinyl ether copolymer, an ethylene-tetrafluoroethylene-hexafluoropropylene-perfluoroalkylvinyl ether copolymer and the like. They may be used either alone or in combination. Among them, ETFE, THV and PVDF are preferably used because of their excellent processability. Further, an ethylene-tetrafluoroethylene-perfluoroalkylvinyl ether copolymer, an ethylene-tetrafluoroethylene-hexafluoropropylene-perfluoroalkylvinyl ether copolymer and THV have superior low fuel permeability to, for example, an ethylene-tetrafluoroethylene-hexafluoropropylene copolymer. Therefore, if a hose is produced using these copolymers in the same thickness, permeation through the hose is smaller, so that the thickness of the resin layer thereof can be reduced, resulting in reducing the production cost. In addition, these copolymers are preferably used because the resulting hose is excellent in insertability and flexibility.

As the material for forming the rubber layer 2, a rubber composition composed of at least one of an amine additive and an amine vulcanizing agent as an essential component is used. The rubber as a main component of this rubber composition is not particularly limited. Examples thereof include epichlorohydrin rubber (ECO), fluororubber (FKM), acrylonitrile-butadiene copolymer rubber (NBR), hydrogenated NBR (H-NBR), a blend polymer (NBR-PVC) of NBR and polyvinyl chloride (PVC), chlorosulfonated polyethylene (CSM), ethylene-propylene-diene rubber (EPDM) and the like. They may be used either alone or in combination.

The amine additive used together with the rubber is not particularly limited as long as it interacts or bonds with a softening component in a PPS resin, or a modified component in a modified fluororesin. Examples thereof include 1,8-diazabicyclo[5.4.0]undecene-7 (DBU) salt of carboxylic acid, DBU salt of a phenol resin, tetramethylammonium hydrogen sulfate, tetraethylammonium hydrogen sulfate, tetrabutylammonium hydrogen sulfate, trioctylmethylammonium hydrogen sulfate, tridodecylmethylammonium hydrogen sulfate, trimethylbenzylammonium hydrogen sulfate, a silane coupling agent of a terminal amine, dodecamethylenediamine and the like. They may be used either alone or in combination. Among them, DBU salt of carboxylic acid and DBU salt of a phenol resin are preferably used because they do not degrade mechanical and physical properties.

The amine additive is preferably present in the range of 0.5 to 3 parts by weight (just abbreviated as ‘parts’, hereinafter), more preferably 0.5 to 2 parts, based on 100 parts of the rubber. If the proportion of the amine additive is smaller than 0.5 parts, interlaminar adhesion between the low permeability resin layer 1 and the rubber layer 2 tends to be poor. If the proportion of the amine additive is greater than 3 parts, mechanical and physical properties of the rubber layer 2 tend to deteriorate.

As the other amine additive, a polymer or an oligomer modified by a terminal amine may be used. Examples thereof include terminal amine modified NBR, terminal amine modified polyamide and the like. The other amine additive is preferably present in the range of 5 to 50 parts, more preferably 5 to 30 parts, based on 100 parts of the rubber. If the other amine additive is smaller than 5 parts, interlaminar adhesion between the low permeability resin layer 1 and the rubber layer 2 tends to be poor. If the proportion of the other amine additive is greater than 50 parts, mechanical and physical properties of the rubber layer 2 tend to deteriorate.

The amine vulcanizing agent used together with the rubber is not particularly limited as long as it interacts or bonds with a softening component in a PPS resin, or a modified component in a modified fluororesin. Examples thereof include N,N′-dicinnamylidene-1,6-hexanediamine, 1,6-hexanediamine, triethylenetetramine, tetraethylenepentamine, triethylenediamine, hexamethylenediamine carbamate [N⁺ H₃ (CH₂)₆ NHCOO⁻], ethylenediamine carbamate, alicyclic amine salt and the like. They may be used either alone or in combination. Among them, N,N′-dicinnamylidene-1,6-hexanediamine is preferably used in terms of safety in processing and physical property balance.

The amine vulcanizing agent is preferably present in the range of 1 to 3 parts, more preferably 1.5 to 3 parts, based on 100 parts of the rubber. If the proportion of the amine vulcanizing agent is smaller than 1 part, interlaminar adhesion between the low permeability resin layer 1 and the rubber layer 2 tends to be poor. If the proportion of the amine vulcanizing agent is greater than 3 parts, mechanical and physical properties of the rubber layer 2 tend to deteriorate.

In addition, the rubber composition for forming the rubber layer 2 may include any of a process aid, an anti-aging agent, a reinforcing agent, a plasticizer, a vulcanizing agent (other than an amine vulcanizing agent), a vulcanizing accelerator, a vulcanizing accelerator aid, a vulcanization retarder, a filler or the like, as required, together with the rubber and at least one of the amine additive and the amine vulcanizing agent.

Examples of the process aid include stearic acid, fatty acid ester, fatty acid amide, a hydrocarbon resin and the like.

Examples of the anti-ageing agent include a carbamate anti-aging agent, a phenylenediamine anti-aging agent, a phenol anti-aging agent, a diphenylamine anti-aging agent, a quinoline anti-aging agent, waxes and the like.

Examples of the reinforcing agent include carbon black, white carbon and the like.

Examples of the plasticizer include a phthalic acid plasticizer such as dioctyl phthalate (DOP) or di-n-butyl phthalate (DBP), an adipic acid plasticizer such as dibutyl carbitol adipate or dioctyl adipate (DOA), a sebacic acid plasticizer such as dioctyl sebacate (DOS) or dibutyl sebacate (DBS) and the like.

Examples of the vulcanizing agent other than the amine vulcanizing agent include sulfur, morpholine, a sulfur compound such as disulfide, an organic peroxide, ethylenethiourea and the like.

Examples of the vulcanizing accelerator include a thiazole accelerator, a thiuram accelerator such as tetramethylthiuram disulfide (TMTD), a sulfenamide accelerator such as N-cyclohexyl-2-benzothiazyl sulfenamide (CBS) and the like.

Examples of the vulcanizing accelerator aid include zinc oxide, active zinc white, magnesium oxide, red lead (red lead primer) and the like.

Examples of the vulcanization retarder include N-(cyclohexylthio)phthalimide and the like.

Examples of the filler include calcium carbonate, magnesium carbonate, clay, talc and the like.

The automotive fuel hose of the invention shown in the FIGURE is produced, for example, by the following process. Namely, the material for forming a low permeability resin layer comprising a PPS resin containing a softening component, or a modified fluororesin is prepared. This material is extruded into a sizing water bath in a reduced pressure by means of an extruder for formation of a low permeability resin layer 1 in a hose shape having desired dimensions. Then, a rubber composition is extruded into a hose shape on the outer peripheral surface of the low permeability resin layer 1 in a hose shape, so that a laminated hose body of the low permeability resin layer 1 in a hose shape and an unvulcanized rubber layer in a hose shape formed on the outer peripheral surface thereof is produced. Further, the laminated hose body is vulcanized at specified conditions so as to adhere the low permeability resin layer 1 in a hose shape directly to the unvulcanized rubber layer in a hose shape formed on the outer periphery thereof. Thus, an automotive fuel hose shown in the FIGURE is produced which has a laminated structure of the low permeability resin layer 1 and the rubber layer 2.

In the above process, the low permeability resin layer 1 is formed by means of a sizing water bath without using a mandrel. However, the mandrel may be used without using the sizing water bath to extrude the low permeability resin layer 1 onto the mandrel. Further, a conductive agent such as carbon black may be blended in the low permeability resin layer (inner layer) 1 to impart conductivity.

In addition, in the present invention, the low permeability resin layer 1 is not limited to a single-layer structure and may have a two-layer structure or a multi-layer structure. For example, the low permeability resin layer 1 may have a two-layer structure, wherein an inner sublayer (innermost layer) is an electrically conductive layer and an outer sublayer is a non-electrically conductive layer. Further, the low permeability resin layer (inner layer) 1 having such a two-layer structure is produced by co-extruding an electrically conductive resin and a non-electrically conductive resin by means of each extruder to be combined into two layers in a die. Still further, in the present invention, a non-low permeability resin layer using a non-low permeability resin (for example, a polyamide resin containing an amino group) may be formed on an inner peripheral surface of the low permeability resin layer 1.

As described above, the low permeability resin layer 1 may have a sandwich structure (three-layer structure) in which the low permeability resin layer 1 is sandwiched between rubber layers by further forming a rubber layer on an inner peripheral surface of the low permeability resin layer 1. As the rubber material for forming the innermost layer (rubber layer) fluororubber, NBR, a blend rubber of NBR and PVC, H-NBR or the like are preferably used in terms of fuel oil resistance. In addition, a reinforcing layer or the like may be provided on an outer periphery of the rubber layer 2.

The automotive fuel hose of the invention thus produced preferably has an inner diameter of 4 to 40 mm, particularly preferably 6 to 33 mm, and an outer diameter of 6 to 50 mm, particularly preferably 8 to 40 mm. The low permeability resin layer 1 preferably has a thickness of 0.05 to 1 mm, particularly preferably 0.1 to 0.6 mm. The rubber layer 2 preferably has a thickness of 0.5 to 5 mm, particularly preferably 1 to 4 mm.

Next, an explanation will be given to the Examples and the Comparative Examples.

Prior to the explanation of the Examples and the Comparative Examples, the materials for the low permeability resin layer were prepared as follows.

PPS Resin

A900 available from Toray Industries, Inc. of Tokyo, Japan

PPS Resin Containing a Softening Component

PPS resin containing a polyolefin thermoplastic elastomer (PZ89-004 available from Toray Industries, Inc. of Tokyo, Japan, the proportion of elastomer: 40% by weight)

Conductive PPS Resin

LKP-15 available from Toray Industries, Inc. of Tokyo, Japan

ETFE

Fluon LM730AP available from Asahi Glass Co., Ltd. of Tokyo, Japan

Acid-Modified ETFE

ETFE containing a carbonate group (RP5000 available from Daikin Industries, Ltd. of Osaka, Japan)

Acid-Modified Conductive ETFE

Electrically conductive ETFE containing a carbonate group (RP5000AS available from Daikin Industries, Ltd. of Osaka, Japan)

Modified Fluororesin (F1)

Ethylene-tetrafluoroethylene-hexafluoropropylene copolymer containing a carbonate group

Modified Fluororesin (F2)

Ethylene-tetrafluoroethylene-perfluoroalkylvinyl ether copolymer containing a carbonate group

Modified Fluororesin (F3)

Ethylene-tetrafluoroethylene-hexafluoropropylene-perfluoroalkylvinyl ether copolymer containing a carbonate group

Modified Fluororesin (F4)

THV containing a carboxylic acid anhydride group

Each material was blended as shown in the following Tables 1 to 4 for preparation of a rubber composition.

TABLE 1
(parts by weight)

| | Rubber composition | | | |
|---|---|---|---|---|
| | A1 | A2 | A3 | A4 |
| Epichlorohydrin rubber | 100 | 100 | 100 | 100 |
| Stearic acid | 2 | 2 | 2 | 2 |
| Magnesium oxide | 5 | — | 5 | — |
| Red lead (red lead primer) | — | 5 | — | 5 |
| Carbon black | 40 | 40 | 40 | 40 |
| Basic silica | 10 | 10 | 10 | 10 |
| Calcium carbonate | 10 | 10 | 10 | 10 |
| Phthalic acid plasticizer (DOP) | 5 | 5 | 5 | 5 |
| Carbamate anti-aging agent | 1 | 1 | 1 | 1 |

Amine additive

| | | | | |
|---|---|---|---|---|
| DBU salt of naphthoic acid | 0.5 | 0.5 | — | 3 |
| Tetramethylammonium hydrogen sulfate | — | — | — | — |
| Vulcanizing agent (ethylenethiourea) | — | 1.5 | — | 1.5 |

Amine vulcanizing agent

| | | | | |
|---|---|---|---|---|
| N,N′-dicinnamylidene-1,6-hexanediamine | 2 | — | 2 | — |
| Triethylene tetramine | — | — | — | — |
| Hexamethylenediamine carbamate | — | — | — | — |
| Alicyclic amine salt | — | — | — | — |

TABLE 2
(parts by weight)

| | Rubber composition | | | | |
|---|---|---|---|---|---|
| | A5 | A6 | A7 | A8 | A9 |
| Epichlorohydrin rubber | 100 | 100 | 100 | 100 | 100 |
| Stearic acid | 2 | 2 | 2 | 2 | 2 |
| Magnesium oxide | 5 | 5 | 5 | 5 | — |
| Red lead (red lead primer) | — | — | — | — | 5 |
| Carbon black | 40 | 40 | 40 | 40 | 40 |
| Basic silica | 10 | 10 | 10 | 10 | 10 |
| Calcium carbonate | 10 | 10 | 10 | 10 | 10 |
| Phthalic acid plasticizer (DOP) | 5 | 5 | 5 | 5 | 5 |
| Carbamate anti-aging agent | 1 | 1 | 1 | 1 | 1 |
| Amine additive | | | | | |
| DBU salt of naphthoic acid | — | 0.5 | 0.5 | 0.5 | — |
| Tetramethylammonium | 0.5 | — | — | — | — |
| hydrogen sulfate | | | | | |
| Vulcanizing agent (ethylenethiourea) | — | — | — | — | 1.5 |
| Amine vulcanizing agent | | | | | |
| N,N'-dicinnamylidene-1,6- | 2 | — | — | — | — |
| hexanediamine | | | | | |
| Triethylene tetramine | — | 2 | — | — | — |
| Hexamethylenediamine | — | — | 2 | — | — |
| carbamate | | | | | |
| Alicyclic amine salt | — | — | — | 2 | — |

TABLE 3
(parts by weight)

| | Rubber composition | | |
|---|---|---|---|
| | B1 | B2 | B3 |
| Ternary fluororubber *1 | 100 | — | 100 |
| Binary fluororubber *2 | — | 100 | — |
| Magnesium oxide | 3 | 3 | 3 |
| Carbon black MT | 20 | 20 | 20 |
| Amine additive (DBU salt of naphthoic acid) | — | 2 | — |
| Amine vulcanizing agent | 3 | 2 | 1 |
| (N,N′-dicinnamylidene-1,6-hexanediamine) | | | |

*1: VdF (Vinylidene fluoride) - TFE (tetrafluoroethylene) - HEP (hexafluoropropylene) fluororubber
*2: VdF-HEP fluororubber

TABLE 4
(parts by weight)

Rubber
composition

| | C1 | C2 |
|---|---|---|
| NBR | 100 | 100 |
| Stearic acid | 1 | 1 |
| Zinc oxide | 5 | 5 |
| Carbon black | 45 | 45 |
| Phthalic acid Plasticizer (DOP) | 25 | 25 |
| Amine additive | | |
| Terminal amine modified NBR *3 | 20 | — |
| Terminal amine modified polyamide *4 | — | 20 |
| Sulfur | 0.3 | 0.3 |
| Vulcanizing accelerator (CBS) | 1.5 | 1.5 |
| Vulcanizing accelerator (TMTD) | 1.5 | 1.5 |

*3: ATBN (BF available from Goodrich Corporation of North Carolina, USA)
*4: VESTAMELT X1027 (available from Daicel-Degussa Ltd. of Tokyo, Japan)

Then, fuel hoses were produced by using the materials for the low permeability resin layer and the rubber compositions as follows.

### EXAMPLES 1 TO 26, COMPARATIVE EXAMPLES 1 TO 5

The materials for forming each layer were prepared as shown in the following Tables 5 to 9. Next, each material was tandem extruded by means of an extruder (In the case of resin/rubber, an inner layer resin was extruded into a hose shape in a sizing water bath and rubber was coated on the outer periphery thereof. In the case of rubber/resin, inner layer rubber was extruded into a hose shape by means of an extruder and a resin was coated on the outer periphery thereof. The third layer or more was sequentially coated on the outer periphery of a two-layer hose. If the third and forth layers were formed by a resin, they may be co-extruded.), and was vulcanized at 160° C. for 45 minutes for obtaining an automotive fuel hose (having an inner diameter of 6 mm) having a low fuel permeability resin layer and a rubber layer. In addition, in the fuel hoses of Examples 16 to 18, an outer layer was formed by PA12, and an adhesive layer composed of a blend of PPS (50 vol %) and PA12 (50 vol %) was extruded at the interface between the PA12 layer and a layer adjacent to the inner side thereof (an intermediate layer) In the hose of Example 19, an adhesive layer was not provided.

Gasoline permeability and interlaminar adhesion of the fuel hoses of Examples and Comparative Examples were evaluated in the following manner. The results are also shown in Tables 5 to 9.

Gasoline Permeability

In the case of resin/rubber, resin/rubber/resin, rubber/resin/resin, opposite end portions of a 10 m long fuel hose (having an inner diameter of 6 mm) were each expanded to an inner diameter of 10 mm by means of a cone-shaped jig. Then, two metal pipes were prepared which each had an outer diameter of 8 mm with two bulged portions each having an outer diameter of 10 mm and with each one end thereof having a rounded outer periphery. These metal pipes were respectively press-fitted into opposite end portions of the hose. In the case of rubber/resin/rubber, opposite end portions of the hose were not expanded. Two metal pipes were prepared which each had an outer diameter of 6.5 mm with one bulged portion having an outer diameter of 7 mm were respectively press-fitted into opposite end portions of the hose. Then, a blind cap was threadingly attached to one of the metal pipes, and a metal valve was attached to the other metal pipe. Thereafter, Indolene gasoline (containing 10 vol % ethanol) was supplied into the fuel hose through the metal valve, and the fuel hose was sealed. The fuel hose was allowed to stand at 40° C. for 3000 hours (the Indolene gasoline containing 10 vol % ethanol was changed every week). Then, gasoline permeability was measured for three days on the basis of a Diurnal Breathing Loss (DBL) pattern by the Sealed Housing for Evaporative Detection (SHED) method in accordance with California Air Resources Board (CARB). Then, gasoline permeability per meter of the hose was determined on a day when the maximum gasoline permeability was detected. In Tables 5 to 9, the notation “<0.1” indicates that the measured gasoline permeability was below the measurement limitation (0.1 mg/m/day) of the aforesaid measurement method.

Interlaminar Adhesion

The fuel hoses having an inner diameter of 6 mm were each longitudinally cut into two strips. By using one of the strips, a peel force (N/cm) required for separating the low permeability resin layer from the rubber layer was determined. Fuel (mixed liquid prepared by blending 10 vol % of ethanol in Fuel C (50 vol % of toluene+50 vol % isooctane)) was supplied into the fuel hose, and the fuel hose was sealed. The fuel hose was allowed to stand at 40° C. for one week. Then, a peel force (N/cm) required for separating the low permeability resin layer from the rubber layer was determined in the same manner as described above. When the fuel hose has two low permeability resin layers in its laminated structure, a peel force (N/cm) required for separating the low permeability resin layer provided on the inner periphery side from the rubber layer adjacent thereto was determined. When the fuel hose has two rubber layers in its laminated structure, a peel force (N/cm) required for separating the rubber layer provided on the inner periphery side from the low permeability resin layer adjacent thereto was determined. As for Examples 20 to 26, a peel force (N/cm) required for separating an inner layer from an intermediate layer and a peel force (N/cm) required for separating an intermediate layer from an outer layer were respectively determined.

TABLE 5

| EXAMPLE | | | | | | | |
|---|---|---|---|---|---|---|---|
| 1 | 2 | 3 | 4 | 5 | 6 | 7 | 8 |

Inner Layer

| | | | | | | | | |
|---|---|---|---|---|---|---|---|---|
| Inner | PPS containing | Electrically | Acid-modified | Acid-modified | Acid-modified | PPS containing | PPS containing | PPS containing |
| sublayer | a softening | conductive PPS | ETFE | electrically | electrically | a softening | a softening | a softening |
| | component | | | conductive ETFE | conductive | component | component | component |
| Outer | | PPS containing | | Acid-modified | ETFE | | | |
| sublayer | | a softening | | ETFE | | | | |
| | | component | | | | | | |
| Outer layer | A1 | A1 | A1 | A1 | A1 | A2 | A3 | A4 |

Thickness (mm)
Inner layer

| | | | | | | | | |
|---|---|---|---|---|---|---|---|---|
| Inner | 0.1 | 0.05 | 0.2 | 0.1 | 0.2 | 0.1 | 0.1 | 0.1 |
| sublayer | | | | | | | | |
| Outer | | 0.1 | | 0.2 | | | | |
| sublayer | | | | | | | | |
| Outer layer | 2 | 2 | 2 | 2 | 2 | 2 | 2 | 2 |
| Gasoline | <0.1 | <0.1 | 3.5 | 2.1 | 4.0 | <0.1 | <0.1 | <0.1 |
| permeability | | | | | | | | |
| (mg/m/day) | | | | | | | | |

Interlaminar adhesion (N/cm)

| | | | | | | | | |
|---|---|---|---|---|---|---|---|---|
| Initial | 67.4 | 82.2 | 21.8 | 26.5 | 9.6 | 43.5 | 59.0 | 49.9 |
| After sealing | 63.0 | 80.7 | 17.1 | 20.2 | 7.7 | 41.3 | 57.4 | 44.1 |

TABLE 6

| EXAMPLE | | | | | | | |
|---|---|---|---|---|---|---|---|
| 9 | 10 | 11 | 12 | 13 | 14 | 15 | 16 |

Inner Layer

| | | | | | | | | |
|---|---|---|---|---|---|---|---|---|
| Inner | PPS containing | PPS containing | PPS containing | PPS containing a | B1 | B2 | B3 | Acid-modified |
| sublayer | a softening | a softening | a softening | softening | | | | ETFE |
| Outer | component | component | component | component | | | | |
| sublayer | | | | | | | | |
| Intermediate | — | — | — | — | PPS containing | PPS containing | PPS containing | B1 |
| layer A | | | | | a softening | a softening | a softening | |
| | | | | | component | component | component | |
| Intermediate | — | — | — | — | — | — | — | PPS containing |
| layer B | | | | | | | | a softening |
| | | | | | | | | component |
| Outer layer | A5 | A6 | A7 | A8 | A1 | A1 | A1 | PA12 |

Thickness (mm)
Inner layer

| | | | | | | | | |
|---|---|---|---|---|---|---|---|---|
| Inner | 0.1 | 0.1 | 0.1 | 0.1 | 0.5 | 0.5 | 0.5 | 0.1 |
| sublayer | | | | | | | | |
| Outer | | | | | | | | |
| sublayer | | | | | | | | |
| Intermediate | — | — | — | — | 0.1 | 0.1 | 0.1 | 0.5 |
| layer A | | | | | | | | |
| Intermediate | — | — | — | — | — | — | — | 0.1 |
| layer B | | | | | | | | |
| Outer layer | 2 | 2 | 2 | 2 | 2 | 2 | 2 | 0.8 |
| Gasoline | <0.1 | <0.1 | <0.1 | <0.1 | <0.1 | <0.1 | <0.1 | <0.1 |
| permeability | | | | | | | | |
| (mg/m/day) | | | | | | | | |

Interlaminar adhesion (N/cm)

| | | | | | | | | |
|---|---|---|---|---|---|---|---|---|
| Initial | 65.9 | 70.3 | 62.1 | 66.6 | 58.9 | 61.7 | 42.2 | 26.6 |
| After | 63.3 | 68.9 | 57.5 | 65.1 | 43.5 | 48.7 | 33.1 | 24.1 |
| sealing | | | | | | | | |

TABLE 7

| EXAMPLE | | |
|---|---|---|
| 17 | 18 | 19 |

Inner Layer

| | | | |
|---|---|---|---|
| Inner sublayer | Acid-modified | B1 | B1 |
| Outer sublayer | electrically | | |
| | conductive ETFE | | |
| Intermediate layer A | B1 | PPS containing a | Acid- |
| | | softening | modified |
| | | component | ETFE |
| Intermediate layer B | PPS containing a | — | — |
| | Softening | | |
| | component | | |
| Outer layer | PA12 | PA12 | PA12 |

Thickness (mm)
Inner layer

| | | | |
|---|---|---|---|
| Inner sublayer | 0.1 | 0.5 | 0.5 |
| Outer sublayer | | | |
| Intermediate layer A | 0.5 | 0.1 | 0.2 |
| Intermediate layer B | 0.1 | — | — |
| Outer layer | 0.8 | 0.8 | 0.8 |
| Gasoline permeability | <0.1 | <0.1 | 3.0 |
| (mg/m/day) | | | |

Interlaminar adhesion (N/cm)

| | | | |
|---|---|---|---|
| Initial | 32.5 | 56.8 | 25.2 |
| After sealing | 27.4 | 42.0 | 23.5 |

TABLE 8

| | EXAMPLE | | | | | | |
|---|---|---|---|---|---|---|---|
| | 20 | 21 | 22 | 23 | 24 | 25 | 26 |
| Inner layer | C1 | C2 | B1 | C2 | C2 | B1 | C2 |
| Intermediate layer | F1 | F1 | F1 | F2 | F3 | F3 | F4 |
| Outer layer | A1 | A1 | A1 | A1 | A1 | A1 | A1 |

Thickness (mm)

| | | | | | | | |
|---|---|---|---|---|---|---|---|
| Inner layer | 1 | 11 | 0.5 | 1 | 1 | 0.5 | 1 |
| Intermediate layer | 0.1 | 0.1 | 0.1 | 0.1 | 0.1 | 0.1 | 0.1 |
| Outer layer | 2 | 2 | 2 | 2 | 2 | 2 | 2 |
| Gasoline | 4.3 | 4.0 | 3.5 | 1.2 | 1.0 | 0.7 | 1.8 |
| permeability | | | | | | | |
| (mg/m/day) | | | | | | | |

Interlaminar adhesion (inner layer/intermediate layer) (N/cm)

| | | | | | | | |
|---|---|---|---|---|---|---|---|
| Initial | 20.5 | 25.6 | 36.8 | 23.8 | 20.1 | 30.1 | 24.4 |
| After sealing | 10.2 | 11.0 | 29.2 | 10.9 | 9.5 | 24.9 | 10.3 |

Interlaminar adhesion (intermediate layer/outer layer) (N/cm)

| | | | | | | | |
|---|---|---|---|---|---|---|---|
| Initial | 21.5 | 21.5 | 21.5 | 18.7 | 18.5 | 18.5 | 38.1 |
| After sealing | 17.3 | 17.3 | 17.3 | 13.5 | 12.2 | 12.2 | 31.4 |

TABLE 9

| COMPARATIVE EXAMPLE | | | | |
|---|---|---|---|---|
| 1 | 2 | 3 | 4 | 5 |

Inner Layer

| | | | | | |
|---|---|---|---|---|---|
| Inner sublayer | PPS | ETFE | PPS | ETFE | PPS containing |
| Outer sublayer | | | | | a softening |
| | | | | | component |
| Intermediate layer A | — | — | — | — | — |
| Intermediate layer B | — | — | — | — | — |
| Outer layer | A9 | A9 | A1 | A1 | A9 |

Thickness (mm)
Inner layer

| | | | | | |
|---|---|---|---|---|---|
| Inner sublayer | 0.1 | 0.2 | 0.1 | 0.2 | 0.1 |
| Outer sublayer | | | | | |
| Intermediate layer A | — | — | — | — | — |
| Intermediate layer B | — | — | — | — | — |
| Outer layer | 2 | 2 | 2 | 2 | 2 |
| Gasoline permeability | <0.1 | 1.0 | <0.1 | 1.0 | <0.1 |
| (mg/m/day) | | | | | |

Interlaminar adhesion (N/cm)

| | | | | | |
|---|---|---|---|---|---|
| Initial | 0.1 | 0.3 | 0.2 | 0.2 | 0.2 |

| | |
|---|---|
| After sealing | Measurement impossible because no |
| | bonding occurred |

As can be understood from the results, the fuel hoses of the Examples had low gasoline permeability, and had excellent low fuel permeability and excellent interlaminar adhesion between the low permeability resin layer and the rubber layer. Although the fuel hoses of Examples 3, 4, 5, 19 to 22 had slightly higher gasoline permeability compared to those of the other Examples, there was no practical problem. Further, the fuel hoses, in which the low permeability resin layer was formed by F2, F3 and F4 among modified fluororesins, had lower permeability, and thus were more preferred compared to the fuel hose, in which the low permeability resin layer was formed by F1, even if the thicknesses of the low permeability resin layers were the same.

On the other hand, the fuel hose of Comparative Example 1, in which the rubber layer was formed by a rubber composition containing neither an amine additive nor an amine vulcanizing agent, and the low permeability resin layer was formed by a PPS resin not containing a softening component, was remarkably inferior in interlaminar adhesion between the low permeability resin layer and the rubber layer. The fuel hose of Comparative Example 2, in which the rubber layer was formed by a rubber composition containing neither an amine additive nor an amine vulcanizing agent, and the low permeability resin layer was formed by a non-modified fluororesin, was remarkably inferior in interlaminar adhesion between the low permeability resin layer and the rubber layer. The fuel hose of Comparative Example 3, in which the rubber layer was formed by a rubber composition containing an amine additive and an amine vulcanizing agent, but the low permeability resin layer was formed by a PPS resin not containing a softening component, was inferior in interlaminar adhesion between the low permeability resin layer and the rubber layer. The fuel hose of Comparative Example 4, in which the rubber layer was formed by a rubber composition containing an amine additive and an amine vulcanizing agent, but the low permeability resin layer was formed by a non-modified fluororesin, was inferior in interlaminar adhesion between the low permeability resin layer and the rubber layer. The fuel hose of Comparative Example 5, in which the low permeability resin layer was formed by a PPS resin containing a softening component, but the rubber layer was formed by a rubber composition containing neither an amine additive nor an amine vulcanizing agent, was inferior in interlaminar adhesion between the low permeability resin layer and the rubber layer.

The inventive automotive fuel hose is preferably used as a transportation hose for automotive fuel such as gasoline, alcohol-containing gasoline or diesel fuel.

1. An automotive fuel hose comprising a laminated structure of a low permeability resin layer and a rubber layer, the low permeability resin layer being formed by the following (A) and the rubber layer being formed by the following (B).
(A) a polyphenylene sulfide resin containing a softening component, or a modified fluororesin.
(B) a rubber composition composed of at least one of an amine additive and an amine vulcanizing agent as an essential component.

2. An automotive fuel hose as set forth in claim 1, wherein the softening component is a polyolefin component.

3. An automotive fuel hose as set forth in claim 1, wherein the amine additive is at least one selected from the group consisting of 1,8-diazabicyclo[5.4.0]undecene-7 salt of carboxylic acid, 1,8-diazabicyclo[5.4.0]undecene-7 salt of a phenol resin, tetramethylammonium hydrogen sulfate, tetraethylammonium hydrogen sulfate, tetrabutylammonium hydrogen sulfate, trioctylmethylammonium hydrogen sulfate, tridodecylmethylammonium hydrogen sulfate and trimethylbenzylammonium hydrogen sulfate.

4. An automotive fuel hose as set forth in claim 2, wherein the amine additive is at least one selected from the group consisting of 1,8-diazabicyclo[5.4.0]undecene-7 salt of carboxylic acid, 1,8-diazabicyclo[5.4.0]undecene-7 salt of a phenol resin, tetramethylammonium hydrogen sulfate, tetraethylammonium hydrogen sulfate, tetrabutylammonium hydrogen sulfate, trioctylmethylammonium hydrogen sulfate, tridodecylmethylammonium hydrogen sulfate and trimethylbenzylammonium hydrogen sulfate.

5. An automotive fuel hose as set forth in claim 1, wherein the amine vulcanizing agent is at least one selected from the group consisting of N,N′-dicinnamylidene-1,6-hexanediamine, 1,6-hexanediamine, triethylenetetramine, tetraethylenepentamine, triethylenediamine, hexamethylenediamine carbamate, ethylenediamine carbamate and alicyclic amine salt.

6. An automotive fuel hose as set forth in claim 2, wherein the amine vulcanizing agent is at least one selected from the group consisting of N,N′-dicinnamylidene-1,6-hexanediamine, 1,6-hexanediamine, triethylenetetramine, tetraethylenepentamine, triethylenediamine, hexamethylenediamine carbamate, ethylenediamine carbamate and alicyclic amine salt.

7. An automotive fuel hose as set forth in claim 3, wherein the amine vulcanizing agent is at least one selected from the group consisting of N,N′-dicinnamylidene-1,6-hexanediamine, 1,6-hexanediamine, triethylenetetramine, tetraethylenepentamine, triethylenediamine, hexamethylenediamine carbamate, ethylenediamine carbamate and alicyclic amine salt.

8. An automotive fuel hose as set forth in claim 4, wherein the amine vulcanizing agent is at least one selected from the group consisting of N,N′-dicinnamylidene-1,6-hexanediamine, 1,6-hexanediamine, triethylenetetramine, tetraethylenepentamine, triethylenediamine, hexamethylenediamine carbamate, ethylenediamine carbamate and alicyclic amine salt.

9. A method for producing an automotive fuel hose as set forth in claim 1, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

10. A method for producing an automotive fuel hose as set forth in claim 2, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

11. A method for producing an automotive fuel hose as set forth in claim 3, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

12. A method for producing an automotive fuel hose as set forth in claim 4, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

13. A method for producing an automotive fuel hose as set forth in claim 5, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

14. A method for producing an automotive fuel hose as set forth in claim 6, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

15. A method for producing an automotive fuel hose as set forth in claim 7, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.

16. A method for producing an automotive fuel hose as set forth in claim 8, the method comprising the steps of: preparing a laminated hose body of a low permeability resin layer using the above (A) and an unvulcanized rubber layer using the above (B) and vulcanizing the laminated hose body so as to adhere the low permeability resin layer and the unvulcanized rubber layer.
